(19) United States
(12) Patent Application Publication
(10) Pub. No.: US 2023/0104613 A1
(43) Pub. Date: Apr. 6, 2023

(54) DATA MANAGEMENT DEVICE, DATA MANAGEMENT METHOD, AND INPUT TERMINAL

(71) Applicant: TOYOTA JIDOSHA KABUSHIKI KAISHA, Toyota-shi Aichi-ken (JP)

(72) Inventors: Daiki Yokoyama, Gotemba-shi (JP); Tomohiro Kaneko, Mishima-shi (JP)

(73) Assignee: TOYOTA JIDOSHA KABUSHIKI KAISHA, Toyota-shi Aichi-ken (JP)

(21) Appl. No.: 17/893,814

(22) Filed: Aug. 23, 2022

(30) Foreign Application Priority Data
Oct. 5, 2021 (JP) 2021-164283

(51) Int. Cl. H04L 67/125; G16Y 20/40; G16Y 40/35

(52) U.S. Cl. CPC H04L 67/125; G16Y 20/40; G16Y 40/35

(57) ABSTRACT

A data management device includes an information acquisition unit that acquires information indicating a resident's degree of acceptance of data collection in a residential unit, and a sensor setting unit that determines an activating mode of each of a group of sensors in the residential unit based on the information acquired by the information acquisition unit.

### CROSS-REFERENCE TO RELATED APPLICATION

This application claims priority to Japanese Patent Application No. 2021-164283 filed on Oct. 5, 2021, incorporated herein by reference in its entirety.

### BACKGROUND

### 1. Technical Field

The present disclosure relates to a data management device, a data management method, and an input terminal.

### 2. Description of Related Art

Japanese Unexamined Patent Application Publication No. 2013-069084 describes collecting data from a plurality of business entities in a smart city.

In order to make effective use of such data and make use of it in people's lives, it is desirable to collect data not only in public areas used by the general public but also in residential units that directly reflect the living conditions of people.

### SUMMARY

However, when the data is acquired in a residential unit, there is a high possibility that a data collection target person will be specified, and the privacy concerns in terms of the collection data will be increased. Therefore, not all residents of the smart city agree to data collection in the residential units. In addition, there are some people who do not allow data collection for some data and allow data collection for other data.

The present disclosure promotes data collection in the residential unit while taking the privacy of the resident into consideration.

The gist of the present disclosure is as follows.

A data management device according to a first aspect of the present disclosure includes an information acquisition unit that acquires information indicating a resident's degree of acceptance of data collection in a residential unit, and a sensor setting unit that determines an activating mode of each of a group of sensors in the residential unit based on the information.

In the first aspect, the group of sensors may be provided in advance in the residential unit. The sensor setting unit may determine an operating state of each of the group of sensors based on the information.

In the first aspect, the sensor setting unit may determine whether to install each of the group of sensors in the residential unit based on the information.

In the first aspect, the sensor setting unit may reduce the number of sensors which collect data in the residential unit in the group of sensors in a case where the degree of acceptance is low, as compared with a case where the degree of acceptance is high.

In the first aspect, the sensor setting unit may give an incentive to the resident according to the degree of acceptance, and increase the incentive in a case where the degree of acceptance is high, as compared with a case where the degree of acceptance is low.

A data management method according to a second aspect of the present disclosure is executed by a computer, and includes acquiring information indicating a resident's degree of acceptance of data collection in a residential unit, and determining an activating mode of each of a group of sensors in the residential unit based on the information based on the information.

An input terminal according to a third aspect of the present disclosure displays an information input screen for a resident to enter information indicating a resident's degree of acceptance of data collection in a residential unit.

With each aspect of the disclosure, it is possible to promote data collection in the residential unit while taking the privacy of the resident into consideration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a data collection system according to a first embodiment of the disclosure;

FIG. 2 is a diagram schematically illustrating a configuration of a server of FIG. 1;

FIG. 3 is a functional block diagram of a processor of the server;

FIG. 4 is a diagram schematically illustrating a series of flows when an operating state of a group of sensors in a residential unit is determined;

FIG. 5 is a flowchart illustrating a control routine of processing executed in an input terminal in the first embodiment.

FIG. 6 is a flowchart illustrating a control routine of processing executed in a server in the first embodiment;

FIG. 7 is a diagram illustrating an example of an information input screen;

FIG. 8 is a diagram illustrating another example of the information input screen;

FIG. 9 is a diagram illustrating an example of a database showing an operating state of each of a group of sensors provided in the residential unit; and

FIG. 10 is a flowchart illustrating a control routine of processing executed in a server in a second embodiment.

### DETAILED DESCRIPTION OF EMBODIMENTS

Hereinafter, embodiments of the disclosure will be described in detail with reference to the drawings. In the following description, similar components are given the same reference numerals.

### First Embodiment

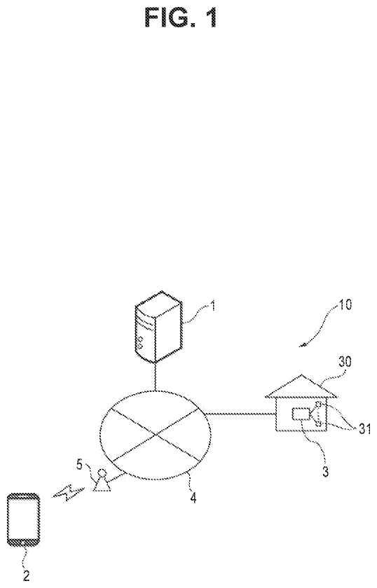

First, a first embodiment of the disclosure will be described with reference to FIGS. 1 to 9.

FIG. 1 is a diagram schematically illustrating a data collection system 10 according to the first embodiment of the disclosure. As illustrated in FIG. 1, the data collection system 10 includes a server 1, an input terminal 2, and a sensor control device 3. The server 1 can communicate with the input terminal 2 and the sensor control device 3 via a communication network 4 such as an Internet network or a carrier network. The server 1 is an example of a data management device.

The server 1 is provided in a predetermined smart city and manages data collection in the smart city. A smart city has a predetermined range and is defined as a “sustainable city or district where management (planning, maintenance, management, operation, and the like) is carried out and overall optimization is achieved while utilizing new technologies such as ICT to solve various problems faced by cities”. In smart cities, a large amount of data is acquired to make people's lives comfortable using information and communication technology.

In a smart city, there are a large number of residential units 30 for people to live in. A residential unit 30 is a place where a specific single person or family lives, and includes a private section of an apartment complex (apartment, etc.), a detached house, and the like. In this embodiment, data is collected not only in a public area used by an unspecified large number of people but also in the residential unit 30. The sensor control device 3 and a group of sensors 31 are provided in each of a plurality of residential units 30, and each of the group of sensors 31 collects predetermined data in the residential unit 30.

The sensor control device 3 has a processor for controlling the group of sensors 31 and a communication portion. The communication portion connects the sensor control device 3 with the communication network 4 via a wire or the like. The sensor control device 3 communicates with the server 1 via the communication network 4. The communication portion may connect the sensor control device 3 with the communication network 4 via a wireless base station 5 by accessing the wireless base station 5.

The sensor control device 3 controls the operating state of the group of sensors 31 based on the command from the server 1. The sensor control device 3 individually sets the operating state of a group of sensors 31. Specifically, the sensor control device 3 sets the operating state of the sensor 31 that acquires data to ON, and sets the operating state of the sensor 31 that does not acquire data to OFF. The data acquired by the sensor 31 is transmitted to the server 1 or another server for data collection, and is used for learning a machine learning model (for example, a neural network model or the like) that predicts power demand or the like.

The input terminal 2 may be, for example, a smartphone, a tablet terminal, a personal computer, or the like, and is operated by a resident of the residential unit 30. The resident of the residential unit 30 includes a person who has already lived in the residential unit 30 and a person who is scheduled to live in the residential unit 30.

The input terminal 2 has a processor that performs various processes on the input terminal 2, an input unit, such as a touch panel, operation buttons, a microphone, a keyboard, and a mouse, an output unit, such as a display and a speaker, and a communication portion. The communication portion connects the input terminal 2 to the communication network 4 via the wireless base station 5 by accessing the wireless base station 5. The input terminal 2 communicates with the server 1 via the wireless base station 5 and the communication network 4. The communication portion may connect the input terminal 2 to the communication network 4 via a wire or the like.

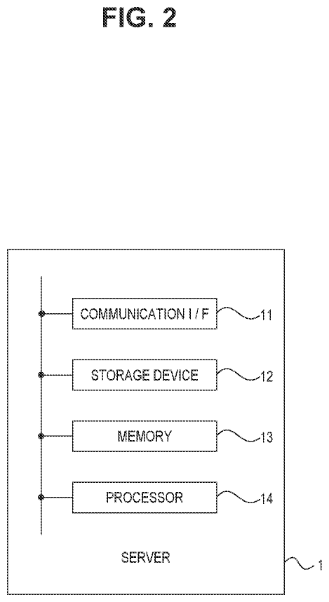

FIG. 2 is a diagram schematically illustrating the configuration of the server 1 in FIG. 1. The server 1 is a kind of computer, and includes a communication interface 11, a storage device 12, a memory 13, and a processor 14. The communication interface 11, the storage device 12, and the memory 13 are connected to the processor 14 via a signal line. The server 1 may further include an input device such as a keyboard and a mouse, an output device such as a display, and the like. Further, the server 1 may be composed of a plurality of computers.

The communication interface 11 has an interface circuit for connecting the server 1 to the communication network 4. The server 1 is connected to the communication network 4 via the communication interface 11 and communicates with the outside (for example, the input terminal 2 and the sensor control device 3) of the server 1 via the communication network 4. The communication interface 11 is an example of the communication portion of the server 1.

The storage device 12 may include, for example, a hard disk drive (HDD), a solid state drive (SDD) or an optical recording medium, and an access device thereof. The storage device 12 stores various data and stores, for example, various pieces of information about the smart city, a computer program for the processor 14 to execute various processes, and the like. The storage device 12 is an example of a storage unit of the server 1.

The memory 13 has a non-volatile semiconductor memory (for example, RAM). The memory 13 temporarily stores various data used when various processes are executed by the processor 14, for example. The memory 13 is another example of the storage unit of the server 1.

The processor 14 has one or a plurality of CPUs and peripheral circuits thereof, and executes various processes. The processor 14 may further include another arithmetic circuit such as a logical arithmetic unit, a numerical arithmetic unit, or a graphic processing unit.

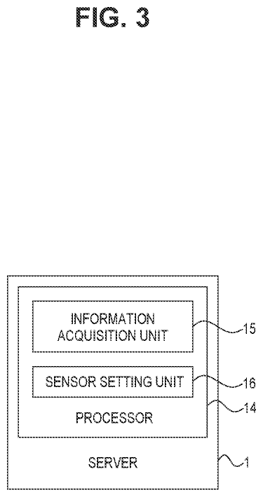

FIG. 3 is a functional block diagram of the processor 14 of the server 1. In this embodiment, the processor 14 has an information acquisition unit 15 and a sensor setting unit 16. The information acquisition unit 15 and the sensor setting unit 16 are functional modules realized by the processor 14 of the server 1 executing the computer program stored in the storage device 12 of the server 1. Each of these functional modules may be realized by a dedicated arithmetic circuit provided in the processor 14.

The information acquisition unit 15 acquires information indicating the resident's degree of acceptance of data collection in the residential unit 30. The sensor setting unit 16 determines the operating mode of each of the group of sensors 31 in the residential unit 30 based on the information acquired by the information acquisition unit 15.

As described above, in this embodiment, data collection is performed in the residential unit 30 using the group of sensors 31. However, when the data is acquired in the residential unit 30, there is a high possibility that a data collection target person will be specified, and the privacy concerns in terms of the collection data will be increased. Therefore, not all residents of the smart city agree to data collection in the residential units 30. In addition, there are some people who do not allow data collection for some data but do allow data collection for other data.

Therefore, in this embodiment, the server 1 acquires information indicating the resident's degree of acceptance of data collection in the residential unit 30 via the input terminal 2, and determines the data collection mode in the residential unit 30 according to the information indicating the degree of acceptance. Specifically, the server 1 determines the operating mode of each of the group of sensors 31 provided in the residential unit 30 according to the information indicating the degree of acceptance input by the resident of the residential unit 30. This makes it possible to promote data collection in the residential unit 30 while also taking the privacy of the resident into consideration.

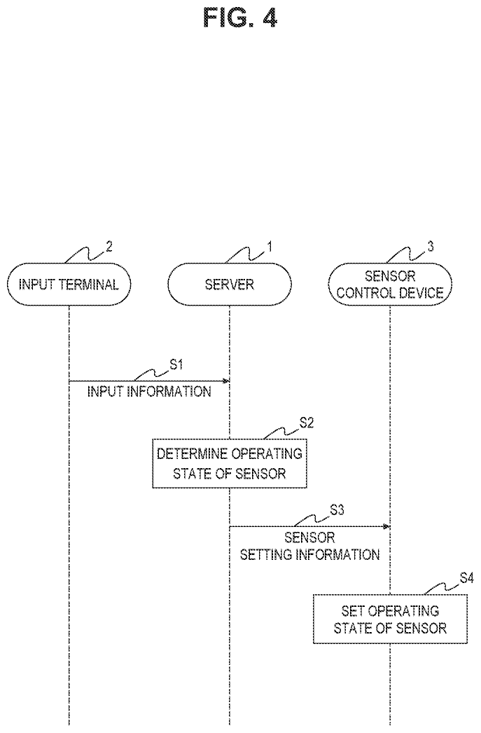

In the present embodiment, the group of sensors 31 is provided in advance in the residential unit 30, and as an activating mode of each of the group of sensors 31, the operating mode of each of the group of sensors 31 is determined. FIG. 4 is a diagram schematically illustrating a series of flows when the operating state of the group of sensors 31 in the residential unit 30 is determined. The processing shown by this sequence diagram is performed on the group of sensors 31 in the residential unit 30 in which the resident resides, in response to a resident's input operation.

First, when a resident of the residential unit 30 operates the input terminal 2, the input terminal 2 displays an information input screen for causing the resident to input information indicating the resident's degree of acceptance of data collection in the residential unit 30. When the resident inputs the information regarding the degree of acceptance on the information input screen, the input terminal 2 transmits the input information to the server 1 (step S1).

Upon receiving the input information from the input terminal 2, the server 1 determines the operating state of each of the group of sensors 31 in the residential unit 30 based on the input information (step S2). Then, the server 1 transmits the sensor setting information including the information regarding the operating state of each of the group of sensors 31 to the sensor control device 3 (step S3).

When the sensor control device 3 receives the sensor setting information from the server 1, the sensor control device 3 sets the operating state of each of the group of sensors 31 based on the sensor setting information (step S4). Specifically, the sensor control device 3 supplies power to the sensor 31 of which the operating state is set to be ON, and stops power supply to the sensor 31 of which the operating state is set to be OFF. When there is a person who is scheduled to live in the residential unit 30, sensor setting information is transmitted from the server 1 to the sensor control device 3 such that the operating state of each of the group of sensors 31 in the residential unit 30 is set by the residence start date.

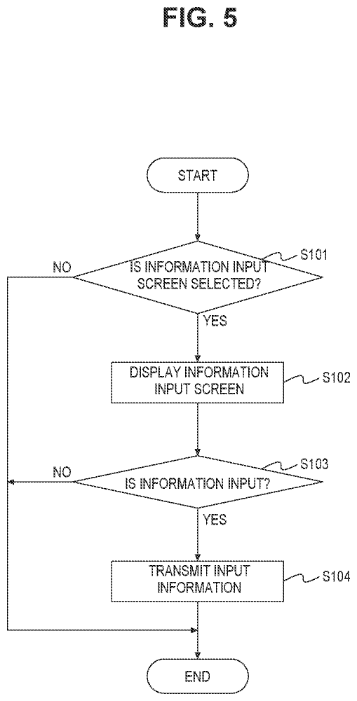

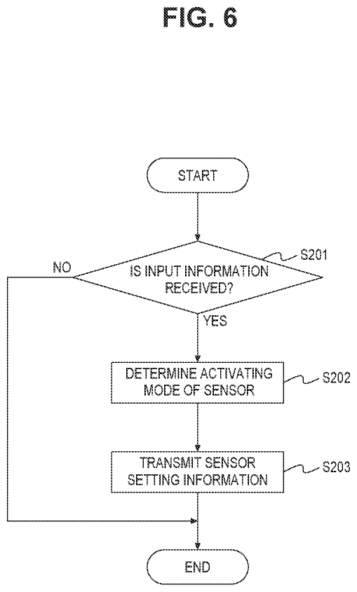

Hereinafter, the above processing will be described in detail with reference to flowcharts of FIGS. 5 and 6. FIG. 5 is a flowchart illustrating a control routine of processing executed in the input terminal 2 in the first embodiment. This control routine is repeatedly executed by the processor of the input terminal 2 at predetermined execution intervals.

First, in step S101, the processor determines in the input terminal 2 whether an information input screen for inputting information indicating the resident's degree of acceptance of data collection in the residential unit 30 has been selected. For example, the input terminal 2 is owned by a resident of the residential unit 30, and the resident selects an information input screen by launching an information input application or accessing a website for inputting information. Further, the input terminal 2 may be owned by a manager (real estate agent, etc.) who manages the residential unit 30, and the manager may select the information input screen to confirm the degree of acceptance of data collection in the resident of the residential unit 30.

When it is determined in step S101 that the information input screen is not selected, this control routine ends. When it is determined in step S101 that the information input screen is selected, this control routine proceeds to step S102.

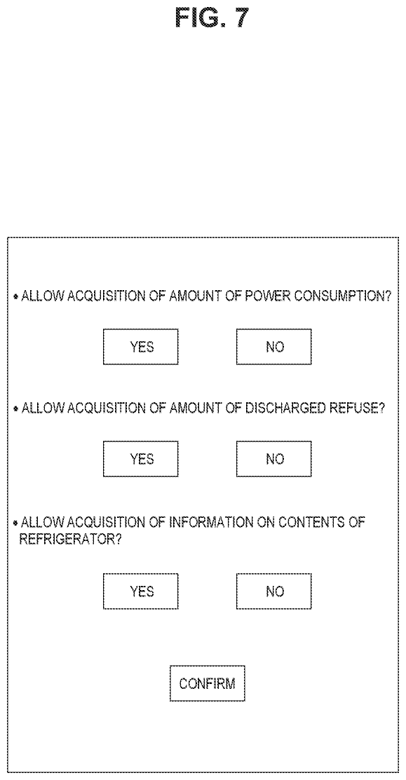

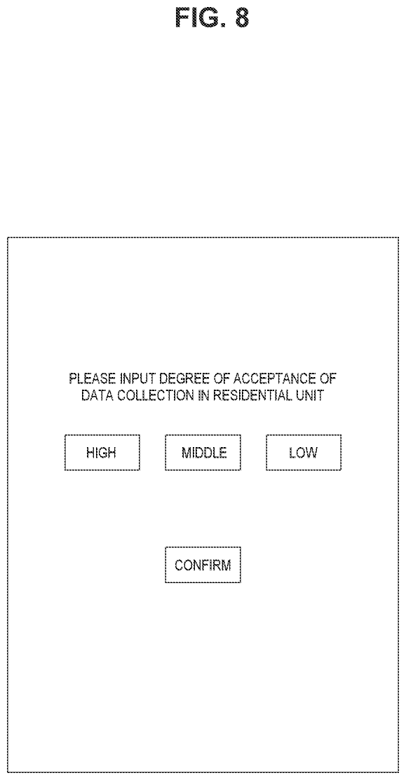

In step S102, the processor displays the information input screen on the output unit of the input terminal 2. FIGS. 7 and 8 are diagrams illustrating examples of the information input screen. In the information input screen illustrated in FIG. 7, all the data collection targets in the residential unit 30 are presented, and an input field for selecting whether to allow or reject the data collection is provided for each of all of the data collection targets. That is, in this case, the resident of the residential unit 30 selects whether to allow or reject data collection for each of all of the data collection targets in the residential unit 30 which is information indicating the resident's degree of acceptance of data collection in the residential unit 30.

An input field for selecting the degree of acceptance of data collection where a plurality of degrees (three stages of high, medium, and low in the example of FIG. 8) is provided as options is provided on the information input screen illustrated in FIG. 8. That is, in this case, the resident of the residential unit 30 selects the degree of acceptance of data collection which is information indicating the resident's degree of acceptance of data collection in the residential unit 30.

Then, in step S103, the processor determines whether information indicating the resident's degree of acceptance of data collection in the residential unit 30 has been input to the input terminal 2. When it is determined that no information has been input, this control routine returns to step S102 and the display of the information input screen is continued. When it is determined that the information has been input, this control routine proceeds to step S104.

In step S104, the processor transmits the input information input to the input terminal 2 to the server 1. After step S104, this control routine ends.

FIG. 6 is a flowchart illustrating a control routine of processing executed in the server 1 in the first embodiment. This control routine is repeatedly executed by the processor 14 of the server 1 at predetermined execution intervals.

First, in step S201, the sensor setting unit 16 determines whether the information acquisition unit 15 has received input information from the input terminal 2. When it is determined that the information acquisition unit 15 has not received the input information, this control routine ends. When it is determined that the information acquisition unit 15 has received the input information, this control routine proceeds to step S202.

In step S202, the sensor setting unit 16 determines the activating mode of each of the group of sensors 31 in the residential unit 30 based on the input information transmitted from the input terminal 2. In this embodiment, the sensor setting unit 16 determines the operating state of each of the group of sensors 31 in the residential unit 30 based on the input information transmitted from the input terminal 2.

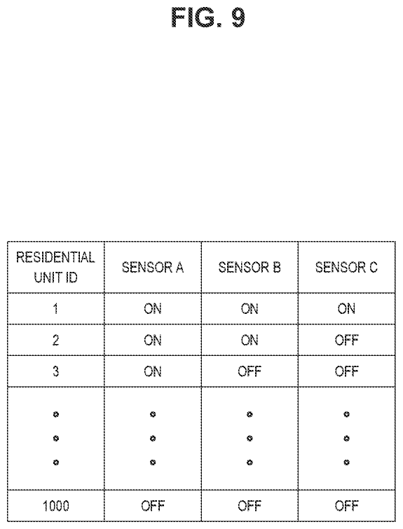

For example, a database representing the operating state of each of the group of sensors 31 for each of a plurality of residential units 30 is stored in the storage device 12 of the server 1. FIG. 9 is a diagram illustrating an example of such a database. In the example of FIG. 9, three sensors (sensors A to sensor C) are used as the group of sensors 31, and the operating state of each of the group of sensors 31 for each of one thousand residential units 30 is shown.

The sensor A is, for example, a watt-hour meter provided in the residential unit 30, and acquires information on the amount of power consumption in the residential unit 30. The sensor B is, for example, a weight sensor provided in a trash can or a garbage chute, and acquires information on the amount of discharged refuse in the residential unit 30. The sensor C is, for example, a camera provided inside the refrigerator, and acquires information on the contents of the refrigerator in the residential unit 30. The sensors 31 provided in the residential unit 30 are not limited to these, and may include a human detecting sensor, an illuminance sensor, a sound level meter, a vibration meter, and the like.

The sensor setting unit 16 updates the information in the database based on the input information transmitted from the input terminal 2. For example, an identifier of the residential unit 30 is transmitted from the input terminal 2 together with the input information to the server 1, and then the sensor setting unit 16 identifies a target residential unit 30 corresponding to the identifier of the residential unit 30, and updates the data regarding the target residential unit 30 based on the input information.

In this update, when the resident's degree of acceptance of data collection is low, the number of sensors 31 of the group of sensors 31 collecting data in the residential unit 30 is set to be smaller than that in the case where the degree of acceptance is high by the sensor setting unit 16. That is, when the resident's degree of acceptance of data collection is low, the sensor setting unit 16 reduces the number of sensors 31 operated in the residential unit 30 of the group of sensors 31, compared to the case where the degree of acceptance is high.

As a specific example of setting the operating state of the group of sensors 31, a case where an information input screen as illustrated in FIG. 7 is used will be described. In this case, when the acquisition of the amount of power consumption is permitted, the sensor setting unit 16 sets the operating state of the sensor A to ON which acquires information on the amount of power consumption. In addition, when the acquisition of the amount of discharged refuse is permitted, the sensor setting unit 16 sets the operating state of the sensor B to ON which acquires the amount of discharged refuse. In addition, when the acquisition of the information on the contents of the refrigerator is permitted, the sensor setting unit 16 sets the operating state of the sensor C to ON which acquires the information on the contents of the refrigerator. When the acquisition of the amount power consumption is refused, the sensor setting unit 16 sets the operating state of the sensor A to OFF which acquires information on the amount of power consumption. In addition, when the acquisition of the amount of discharged refuse is refused, the sensor setting unit 16 sets the operating state of the sensor B to OFF which acquires the amount of discharged refuse. In addition, when the acquisition of the information on the contents of the refrigerator is refused, the sensor setting unit 16 sets the operating state of the sensor C to OFF which acquires the information on the contents of the refrigerator. That is, the sensor setting unit 16 sets the operating state of the sensor 31 to ON for the data collection target for which data collection is permitted, and sets the operating state of the sensor 31 to OFF for the data collection target for which data collection is refused.

When the information input screen as illustrated in FIG. 8 is used, the sensor setting unit 16 determines the number of sensors 31 operated in the residential unit 30 depending on the degree of acceptance selected by the resident. For example, the sensor setting unit 16 sets the operating state of all sensors (sensor A to sensor C) to ON when the selected degree of acceptance is “high”, sets the operating state of some sensors (for example, sensor A and sensor B) to ON when the selected degree of acceptance is “medium”, and sets the operating state of all sensors (sensor A to sensor C) to OFF when the selected degree of acceptance is “low”.

Next, in step S203, the sensor setting unit 16 transmits sensor setting information including information regarding the operating state of each of the group of sensors 31 to the sensor control device 3 provided in the target residential unit 30. The sensor control device 3 sets the operating state of each of the group of sensors 31 according to the sensor setting information. After step S203, this control routine ends.

In the processing described above, it is assumed that the group of sensors 31 are still installed in the residential unit 30. However, the installation mode of the group of sensors 31 may be changed according to the construction of a new residential unit 30, a change of a resident who resides in the residential unit 30, and the like. In this case, the resident of the residential unit 30 inputs information indicating the resident's degree of acceptance of data collection in the residential unit 30 into the input terminal 2 before moving into the residential unit 30. Further, in this case, the processing of steps S202 and S203 is changed as follows.

In step S202, the sensor setting unit 16 determines whether to install each of the group of sensors 31 in the residential unit 30 based on the input information acquired by the information acquisition unit 15. For example, according to the determination of the sensor setting unit 16, a sensor 31 for the data collection target for which data collection is permitted is installed in the residential unit 30, and a sensor 31 for the data collection target for which data collection is refused is not installed in the residential unit 30. When it is determined whether to install the sensor 31 in the residential unit 30 in the activation mode of the sensor 31, in the database stored in the storage device 12, the installation state (installation or non-installation) of the sensor 31 is described instead of the operating state of the sensor 31.

Next, in step S203, the sensor setting unit 16 transmits the sensor setting information including information on whether to install the group of sensors 31 in each residential unit 30 to a terminal of a contractor or the like that undertakes the installation work of the sensors 31. As a result, the installation work of the sensor 31 in the residential unit 30 is performed according to the sensor setting information.

### Second Embodiment

The configuration and control of the data management device according to a second embodiment are basically the same as the configuration and control of the data management device according to the first embodiment, except for the points described below. Therefore, hereinafter, the second embodiment of the disclosure will be described focusing on the parts different from the first embodiment.

As described above, the server 1 determines the mode of data collection in the residential unit 30 according to the information indicating the resident's degree of acceptance of data collection. However, when the benefits that residents can enjoy by providing data are unclear, it is expected that the number of residents who refuse to provide highly private data will increase.

Therefore, in the second embodiment, the sensor setting unit 16 of the server 1 gives the resident an incentive according to the resident's degree of acceptance of data collection in the residential unit 30, and when the degree of acceptance is high, the incentive is set to be larger than when the degree of acceptance is low. As a result, it is possible to reduce a feeling of reluctance to agreeing to the provision of data, and to further promote data collection in the residential unit 30.

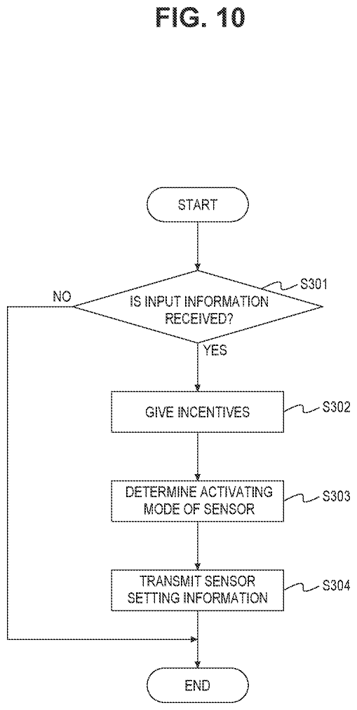

In the second embodiment, the control routine of FIG. 5 is executed in the input terminal 2 and the control routine of FIG. 10 is executed in the server 1 as in the first embodiment. FIG. 10 is a flowchart indicating the control routine of processing executed by the server 1 in the second embodiment. This control routine is repeatedly executed by the processor 14 of the server 1 at predetermined execution intervals.

First, in step S301, the sensor setting unit 16 determines whether the information acquisition unit 15 has received the input information from the input terminal 2. When it is determined that the information acquisition unit 15 has not received the input information, this control routine ends. When it is determined that the information acquisition unit 15 has received the input information, the control routine proceeds to step S302.

In step S302, the sensor setting unit 16 gives the resident an incentive according to the resident's degree of acceptance of data collection in the residential unit 30. For example, the sensor setting unit 16 gives an incentive when the degree of acceptance is equal to or more than a predetermined value, and does not give an incentive when the degree of acceptance is less than the predetermined value. Further, the sensor setting unit 16 increases the incentive when the degree of acceptance is high as compared with the case where the degree of acceptance is low. The incentive, for example, may be a reduction in rent for the residential unit 30, and when the degree of acceptance is high, the degree of reduction in rent is larger than when the degree of acceptance is low. Further, when the incentive is a voucher, such as gift certificate, tickets for self-driving vehicles (for example, self-driving buses), taxi tickets, and the degree of acceptance is high, the value of the granted voucher may be higher than in the case where the degree of acceptance is low.

Then, steps S303 and S304 are executed in the same manner as steps S202 and S203 of FIG. 6, and the control routine ends. The control routine of FIG. 10 can be modified in the same manner as the control routine of FIG. 6.

### Other Embodiments

Although the embodiments of the disclosure are described above, the disclosure is not limited to these embodiments, and various modifications and changes can be made within the scope of the claims. The input terminal 2, for example, may function as a data management device instead of the server 1. In this case, the server 1 is omitted, and sensor setting information is transmitted from the input terminal 2 to the sensor control device 3 or a terminal of a contractor or the like.

Further, the sensor control device 3 may function as a data management device instead of the server 1. In this case, the server 1 is omitted, and input information is transmitted from the input terminal 2 to the sensor control device 3. Further, the server 1 and the input terminal 2 may be omitted, and the sensor control device 3 may have an input portion (for example, a touch panel) in which information indicating the resident's degree of acceptance of data collection in the residential unit 30 is input.

What is claimed is:

1. A data management device comprising:
an information acquisition unit configured to acquire information indicating a resident's degree of acceptance of data collection in a residential unit; and
a sensor setting unit configured to determine an activating mode of each of a group of sensors in the residential unit based on the information.

2. The data management device according to claim 1, wherein:
the group of sensors is provided in advance in the residential unit; and
the sensor setting unit is configured to determine an operating state of each of the group of sensors based on the information.

3. The data management device according to claim 1, wherein the sensor setting unit is configured to determine whether to install each of the group of sensors in the residential unit based on the information.

4. The data management device according to claim 1, wherein the sensor setting unit is configured to reduce the number of sensors which collect data in the residential unit in the group of sensors in a case where the degree of acceptance is low, as compared with a case where the degree of acceptance is high.

5. The data management device according to claim 1, wherein the sensor setting unit is configured to give an incentive to the resident according to the degree of acceptance, and increase the incentive in a case where the degree of acceptance is high, as compared with a case where the degree of acceptance is low.

6. A data management method executed by a computer, the data management method comprising:
acquiring information indicating a resident's degree of acceptance of data collection in a residential unit; and
determining an activating mode of each of a group of sensors in the residential unit based on the information.

7. An input terminal that displays an information input screen for a resident to enter information indicating a resident's degree of acceptance of data collection in a residential unit.
